(19) United States
(12) Patent Application Publication
(10) Pub. No.: US 2026/0319652 A1
(43) Pub. Date: Oct. 15, 2026

(54) INTERACTION METHOD, DISPLAY TOUCH DEVICE, AND STORAGE MEDIUM

(71) Applicants: Beijing BOE Technology Development Co., Ltd., Beijing (CN); BOE Technology Group Co., Ltd., Beijing (CN)

(72) Inventor: Hengfei ZHANG, Beijing (CN)

(21) Appl. No.: 18/880,851

(22) PCT Filed: Apr. 22, 2024
(86) PCT No.: PCT/CN2024/089082

§ 371 Date: Jan. 3, 2025

(30) Foreign Application Priority Data
May 22, 2023 (CN) 202310580180.4

(51) Int. Cl. G06F 3/0488; G06F 3/01; G06F 3/041; G06F 3/04817

(52) U.S. Cl. CPC G06F 3/0488; G06F 3/016; G06F 3/0414; G06F 3/04817

(57) ABSTRACT

An interaction method, comprising: determining a touch operation for a target object on a graphical user interface, and determining touch parameter information of the touch operation; generating a haptic signal according to the touch parameter information of the touch operation; and when it is detected that the touch parameter information of the touch operation changes, updating the touch signal according to the updated touch parameter information. The haptic signal is configured to drive a haptic feedback apparatus to generate a corresponding haptic feedback effect. The touch parameter information comprises at least one of the following: touch position, touch pressure, the number of touch points, touch area, touch duration, and touch order.

### CROSS-REFERENCE TO RELATED APPLICATIONS

The present application is a U.S. National Phase Entry of International Application No. PCT/CN2024/089082 having an international filing date of Apr. 22, 2024, which claims priority to Chinese patent application No. 202310580180.4, filed to the CNIPA on May 22, 2023, contents of the above-identified applications should be interpreted as being incorporated into the present application by reference.

### TECHNICAL FIELD

The present disclosure relates to, but is not limited to, the field of display technologies, and in particular, an interaction method, a display touch device, and a storage medium.

### BACKGROUND

A touch panel, also known as a touch screen or a touch panel, is an inductive display apparatus that may receive an input signal from a contact head or the like, which has formed commercial touch screen technologies and includes: a resistance technology touch screen, a capacitance technology touch screen, an infrared technology touch screen, and a surface acoustic wave technology touch screen, etc., and has been widely used in many fields such as mobile phones, tablet computers, retail, public information inquiry, multimedia information systems, medical instruments, industrial automatic control, entertainment and catering, automated ticketing systems, education systems, and so on.

### SUMMARY

The following is a summary of subject matters described herein in detail. This summary is not intended to limit the protection scope of claims.

Embodiments of the present disclosure provide an interaction method, a display touch device, and a storage medium.

In one aspect, an embodiment of the present disclosure provides an interaction method, including: determining a touch operation for a target object in a graphical user interface, and determining touch parameter information of the touch operation; generating a haptic signal according to the touch parameter information of the touch operation; when it is detected that the touch parameter information of the touch operation changes, updating the haptic signal according to updated touch parameter information. The haptic signal is configured to drive a haptic feedback apparatus to generate a corresponding haptic feedback effect. The touch parameter information includes at least one of following: a touch position, a touch pressure, a quantity of touch points, a touch area, a touch duration, and a touch sequence.

In some exemplary implementation modes, the haptic signal is characterized by at least one of following parameters: a waveform type, a waveform amplitude, and a waveform frequency.

In some exemplary implementation modes, the generating the haptic signal according to the touch parameter information of the touch operation includes: determining a corresponding relationship between the touch parameter information and a parameter of the haptic signal according to a type of the target object and a type of the touch operation for the target object; and generating the haptic signal according to the touch parameter information and the corresponding relationship between the touch parameter information and the parameter of the haptic signal.

In some exemplary implementation modes, the determining the corresponding relationship between the touch parameter information and the parameter of the haptic signal according to the type of the target object and the type of the touch operation for the target object includes at least one of: when the target object includes a control bar control and the touch operation for the target object is a sliding operation, determining that a waveform frequency of the haptic signal depends on a touch position of the touch operation; when the target object includes a button control and the touch operation for the target object is a click operation, determining that a waveform amplitude of the haptic signal depends on a touch pressure of the touch operation; when the target object includes a multi-touch region and the touch operation for the target object is a click operation, determining that a waveform type of the haptic signal depends on a quantity of touch points of the touch operation.

In some exemplary implementation modes, the control bar control is divided into a plurality of first sub-regions along a length direction of the control bar control, and waveform frequencies of haptic signals corresponding to the plurality of first sub-regions change along the length direction of the control bar control. When the target object includes the control bar control and the touch operation for the target object is the sliding operation, the generating the haptic signal according to the touch parameter information and the corresponding relationship between the touch parameter information and the parameter of the haptic signal includes: determining a first sub-region where a contact point is located in the control bar control according to a touch position of the contact point of the sliding operation; and generating the haptic signal according to a waveform frequency corresponding to the first sub-region.

In some exemplary implementation modes, the updating the haptic signal according to the updated touch parameter information includes: determining a first sub-region where a contact point is located in the control bar control according to an updated touch position of the contact point of the sliding operation; and updating the haptic signal according to a waveform frequency corresponding to the first sub-region.

In some exemplary implementation modes, the button control corresponds to a plurality of touch pressure ranges, and waveform amplitudes of haptic signals corresponding to the plurality of touch pressure ranges change with numerical values of the plurality of touch pressure ranges. When the target object includes the button control and the touch operation for the target object is the click operation, the generating the haptic signal according to the touch parameter information and the corresponding relationship between the touch parameter information and the parameter of the haptic signal includes: determining a touch pressure range to which a touch pressure of the click operation belongs according to the touch pressure of the click operation; and generating the haptic signal according to a waveform amplitude corresponding to the determined touch pressure range.

In some exemplary implementation modes, the updating the haptic signal according to the updated touch parameter information includes: determining a touch pressure range to which an updated touch pressure belongs according to the updated touch pressure of the click operation; and updating the haptic signal according to a waveform amplitude corresponding to the updated touch pressure range.

In some exemplary implementation modes, the multi-touch region corresponds to a plurality of contact point ranges, and waveform types corresponding to the plurality of contact point ranges are different. When the target object includes the multi-touch region and the touch operation for the target object is the click operation, the generating the haptic signal according to the touch parameter information and the corresponding relationship between the touch parameter information and the parameter of the haptic signal includes: determining a contact point range to which a quantity of touch points belongs according to the quantity of touch points of the click operation; and generating the haptic signal according to a waveform type corresponding to the determined contact point range.

In some exemplary implementation modes, the updating the haptic signal according to the updated touch parameter information includes: determining a contact point range to which an updated quantity of touch points belongs according to the updated quantity of touch points of the click operation; and updating the haptic signal according to a waveform type corresponding to the updated contact point range.

In some exemplary implementation modes, the haptic feedback effect includes a haptic feedback effect generated based on a film pressing effect.

In some exemplary implementation modes, the determining the touch operation for the target object in the graphical user interface includes: determining that the touch operation is a touch operation for the target object, when a touch position of the touch operation is located in a region where the target object is located and a type of the target object matches a type of the touch operation.

In another aspect, an embodiment of the present disclosure provides a display touch device, including: a display touch panel, a processor, and a haptic feedback apparatus, wherein the processor is connected with the display touch panel and the haptic feedback apparatus. The display touch panel is configured to acquire touch parameter information of a touch operation in a graphical user interface. The processor is configured to: determine a touch operation for a target object in the graphical user interface; generate a haptic signal according to touch parameter information of the touch operation; and when it is detected that the touch parameter information of the touch operation changes, update the haptic signal according to updated touch parameter information. The touch parameter information includes at least one of following: a touch position, a touch pressure, a quantity of touch points, a touch area, a touch duration, and a touch sequence. The haptic feedback apparatus is configured to generate a corresponding haptic feedback effect according to the haptic signal.

In some exemplary implementation modes, the haptic signal is characterized by at least one of following parameters: a waveform type, a waveform amplitude, and a waveform frequency.

In some exemplary implementation modes, the processor is configured to generate the haptic signal according to the touch parameter information of the touch operation by: determining a corresponding relationship between the touch parameter information and a parameter of the haptic signal according to a type of the target object and a type of the touch operation for the target object; and generating the haptic signal according to the touch parameter information and the corresponding relationship between the touch parameter information and the parameter of the haptic signal.

In some exemplary implementation modes, the processor is configured to determine the corresponding relationship between the touch parameter information and the parameter of the haptic signal according to the type of the target object and the type of touch operation for the target object by at least one of following: when the target object includes a control bar control and the touch operation for the target object is a sliding operation, determining that a waveform frequency of the haptic signal depends on a touch position of the touch operation; when the target object includes a button control and the touch operation for the target object is a click operation, determining that a waveform amplitude of the haptic signal depends on a touch pressure of the touch operation; and when the target object includes a multi-touch region and the touch operation for the target object is a click operation, determining that a waveform type of the haptic signal depends on a quantity of touch points of the touch operation.

In some exemplary implementation modes, the control bar control is divided into a plurality of first sub-regions along a length direction of the control bar control, and waveform frequencies of haptic signals corresponding to the plurality of first sub-regions change along the length direction of the control bar control. When the target object includes a control bar control and the touch operation for the target object is a sliding operation, the processor is configured to generate the haptic signal according to the touch parameter information and the corresponding relationship between the touch parameter information and the parameter of the haptic signal by: determining a first sub-region where a contact point is located in the control bar control according to a touch position of the contact point of the sliding operation; and generating the haptic signal according to a waveform frequency corresponding to the first sub-region.

In some exemplary implementation modes, the button control corresponds to a plurality of touch pressure ranges, and waveform amplitudes of haptic signals corresponding to the plurality of touch pressure ranges change with numerical values of the plurality of touch pressure ranges. When the target object includes the button control and the touch operation for the target object is the click operation, the processor is configured to generate the haptic signal according to the touch parameter information and the corresponding relationship between the touch parameter information and the parameter of the haptic signal by: determining a touch pressure range to which a touch pressure of the click operation belongs according to the touch pressure of the click operation; and generating the haptic signal according to a waveform amplitude corresponding to the determined touch pressure range.

In some exemplary implementation modes, the multi-touch region corresponds to a plurality of contact point ranges, and waveform types corresponding to the plurality of contact point ranges are different. When the target object includes the multi-touch region and the touch operation for the target object is the click operation, the processor is configured to generate the haptic signal according to the touch parameter information and the corresponding relationship between the touch parameter information and the parameter of the haptic signal by: determining a contact point range to which a quantity of touch points belongs according to the quantity of touch points of the click operation; and generating the haptic signal according to a waveform type corresponding to the determined contact point range.

In some exemplary implementation modes, the haptic feedback apparatus includes at least a piezoelectric ceramic sheet.

In another aspect, an embodiment of the present disclosure provides a non-transitory computer readable storage medium, on which a computer program is stored. Acts of the interaction method as described above are implemented when the computer program is executed.

Other aspects of the present disclosure may be comprehended after drawings and detailed description are read and understood.

### BRIEF DESCRIPTION OF DRAWINGS

Accompanying drawings are used for providing further understanding of technical solutions of the present disclosure, constitute a part of the specification, and are used for explaining the technical solutions of the present disclosure together with the embodiments of the present disclosure, but do not constitute limitations on the technical solutions of the present disclosure. Shapes and sizes of one or more components in the drawings do not reflect actual scales, but are only intended to schematically describe contents of the present disclosure.

FIG. 1 is a schematic flowchart of an interaction method according to at least one embodiment of the present disclosure.

FIG. 2 is a schematic diagram of a display touch device according to at least one embodiment of the present disclosure.

FIG. 3 is a schematic plan view of a haptic feedback apparatus according to at least one embodiment of the present disclosure.

FIG. 4 is an exemplary flowchart of an interaction method according to at least one embodiment of the present disclosure.

FIG. 5 is a schematic diagram of a control bar control according to at least one embodiment of the present disclosure.

FIGS. 6A and 6B are operation example diagrams of at least one embodiment of the present disclosure.

FIG. 7 is a schematic diagram of a knob control according to at least one embodiment of the present disclosure.

FIG. 8 is another exemplary flowchart of an interaction method according to at least one embodiment of the present disclosure.

FIGS. 9A and 9B are operation example diagrams of at least one embodiment of the present disclosure.

FIG. 10 is another flowchart of an interaction method according to at least one embodiment of the present disclosure.

FIGS. 11A and 11B are operation example diagrams of at least one embodiment of the present disclosure.

### DETAILED DESCRIPTION

The embodiments of the present disclosure will be described below with reference to the drawings in detail. Implementation modes may be implemented in multiple different forms. Those of ordinary skills in the art may easily understand such a fact that modes and contents may be transformed into other forms without departing from the purpose and scope of the present disclosure. Therefore, the present disclosure should not be explained as being limited to contents recorded in following implementation modes only. The embodiments and features in the embodiments of the present disclosure may be randomly combined with each other if there is no conflict.

In the drawings, a size of one or more constituent elements, a thickness of a layer, or a region is sometimes exaggerated for clarity. Therefore, one mode of the present disclosure is not necessarily limited to the size, and a shape and a size of one or more components in the drawings do not reflect an actual scale. In addition, the accompanying drawings schematically illustrate ideal examples, and one mode of the present disclosure is not limited to shapes, numerical values, or the like shown in the drawings.

Ordinal numerals “first”, “second”, “third”, etc., in the specification are set not to form limits in numbers but only to avoid confusion between constituent elements. In the present disclosure, “plurality” represents two or more than two.

In the specification, for convenience, expressions “central”, “above”, “below”, “front”, “back”, “vertical”, “horizontal”, “top”, “bottom”, “inside”, “outside”, etc., for indicating directional or positional relationships are used to illustrate positional relationships between the constituent elements with reference to the accompanying drawings, not to indicate or imply that a referred apparatus or element must have a specific orientation or be structured and operated in the specific orientation but only to easily describe the present specification and simplify the description, and thus should not be understood as limitations on the present disclosure. The positional relationships between the constituent elements are changed as appropriate according to directions of the constituent elements described. Therefore, appropriate replacements based on situations are allowed, which is not limited to the expressions in the specification.

In the specification, unless otherwise explicitly specified and defined, terms “mounting”, “coupling”, and “connection” should be understood in a broad sense. For example, it may be a fixed connection, a detachable connection, or an integral connection; it may be a mechanical connection or a connection; it may be a direct connection, an indirect connection through a middleware, or internal communication inside two elements. Those of ordinary skills in the art may understand meanings of the aforementioned terms in the present disclosure according to situations. In the specification, an “electrical connection” includes a case that constituent elements are connected together through an element with a certain electrical action. The “element with a certain electrical action” is not particularly limited as long as electrical signals between the connected constituent elements may be transmitted. Examples of the “element with a certain electrical action” not only include an electrode and a wiring, but also include a switching element such as a transistor, a resistor, an inductor, a capacitor, and other elements with a plurality of functions, etc.

With development of technologies, people have an urgent need for haptic perception and haptic reproduction in a process of human-computer interaction. However, at present, a haptic perception effect in the process of human-computer interaction is relatively simple, which easily leads to monotonous haptic feeling of users, resulting in poor user experience.

The embodiments provide an interaction method, a display touch device, and a storage medium, which may improve a situation in which user experience is affected adversely by a simple haptic perception effect in a human-computer interaction process.

FIG. 1 is a schematic flowchart of an interaction method according to at least one embodiment of the present disclosure. In some examples, as shown in FIG. 1, the interaction method provided by the present embodiment may include following acts.

Act 11: determining a touch operation for a target object in a Graphical User Interface (GUI), and determining touch parameter information of the touch operation.

Act 12: generating a haptic signal according to the touch parameter information. Herein, the haptic signal is configured to drive a haptic feedback apparatus to generate a corresponding haptic feedback effect.

Act 13: when it is detected that the touch parameter information of the touch operation changes, updating the haptic signal according to updated touch parameter information.

In some examples, corresponding haptic feedback may be generated for a user's touch operation on the target object. For example, the GUI may display a GUI control (including, for example, a button control, a control bar control, a knob control, and the like), the user may perform a touch operation (including, for example, a click operation, a sliding operation, and the like) on the GUI control, and for the user's touch operation on the GUI control, a haptic feedback effect corresponding to the GUI control and the touch operation may be generated through the haptic feedback apparatus. Further, in a changing process of a touch parameter for the touch operation on the GUI control, the corresponding haptic feedback effect may be adjusted according to change of the touch parameter, so that the user may feel a rich haptic feedback effect, thereby enhancing user experience.

In the interaction method of the present embodiment, the haptic signal may be determined through touch parameter information of the touch operation for the target object, and the haptic signal may change with change of the touch parameter information of the touch operation, thereby generating a rich haptic feedback effect. In this way, not only the user's interaction experience may be enriched, but also the user's touch operation may be effectively guided based on different haptic feedback effects, for example, the user's blind operation may be prompted and guided.

In some examples, when it is detected that the touch parameter information of the touch operation for the target object is not changed, the haptic signal may be kept unchanged in order to produce a haptic feedback effect consistent with that before. When it is detected that the touch operation for the target object is finished, output of the haptic signal may be stopped, and haptic feedback may be performed when a next touch operation for the target object is detected.

In some examples, after the touch operation for the target object is detected, the touch parameter information of the touch operation may be detected and acquired in real time, and whether the touch parameter information changes may be determined according to the continuously acquired touch parameter information, so as to change the haptic signal according to change of the touch parameter information. In other examples, after the touch operation for the target object is detected, the touch parameter information of the touch operation may be periodically detected and acquired, and whether the touch parameter information changes may be determined according to the periodically acquired touch parameter information, so as to change the haptic signal according to change of the touch parameter information. The present embodiment is not limited thereto.

In some examples, the interaction method of the present embodiment may be applied to a display touch device. The display touch device may be an electronic device having a display function and a touch function. For example, the display touch device may include: a mobile phone, a tablet computer, a wearable device, a vehicle-mounted device, a central control device, and the like. Herein, the display touch device may receive a touch operation of the user, and generate a corresponding haptic feedback effect for the touch operation for the target object through the haptic feedback apparatus. However, the present embodiment is not limited thereto.

In some examples, application scenarios of the interaction method of the present embodiment may include, but are not limited to, scenarios such as smart home, smart wear, smart transportation, and smart finance.

In some examples, the touch parameter information of the touch operation may include at least one of a touch position, a touch pressure, a quantity of touch points, a touch area, a touch duration, and a touch sequence. The touch parameter information of the present example may be parameter information characterizing an attribute characteristic of the touch operation. For example, the touch parameter information of the touch operation may include: a touch position, a touch pressure, a quantity of touch points, a touch area, a touch duration, or a touch sequence. For another example, the touch parameter information may include: a touch position and a touch pressure, or, a touch position and a touch area, or, a touch position and a touch duration, or, a touch pressure and a touch duration. Combination of touch parameters included in the touch parameter information is not limited in the present embodiment.

In some examples, the touch position may represent a position where the touch operation is located on a touch surface of the display touch device. For example, the touch operation is a click operation, and the touch position may include coordinate information of a contact point of the click operation on a touch surface of the display touch device. For example, the touch operation is a sliding operation, and the touch position of the sliding operation collected at a certain moment may include coordinate information of a contact point of the sliding operation on the touch surface of the display touch device at that moment. For the sliding operation, a touch displacement of the sliding operation may be determined according to change of the touch position. In some examples, the display touch device may include a capacitive touch panel to identify a position of a contact point on the touch surface. The present embodiment is not limited thereto.

In some examples, the touch pressure may refer to a force exerted by a user's finger on a touch surface of the display touch device while performing a touch operation. For example, the touch operation is a click operation, and the touch pressure may be a magnitude of a force exerted by the click operation on the touch surface of the display touch device. For example, the display touch device may include a pressure detection sensor (e.g., a piezoelectric ceramic sheet) which may detect the touch pressure of the touch operation on the touch surface.

In some examples, the quantity of touch points may refer to a quantity of contact points that a user's finger exerts on the touch surface of the display touch device while performing a touch operation. For the display touch panel that supports multi-touch, a quantity of touch points of the touch operation may be collected. For example, the display touch device may include a capacitive touch panel to collect the quantity of contact points on the touch surface.

In some examples, the touch area may refer to a contact area of the user's finger with the touch surface of the display touch device when performing the touch operation. For example, the touch operation is a click operation with only one contact point, and the touch area may be a contact area of a single contact point of the click operation. For another example, the touch operation is a click operation and includes a plurality of contact points, and the touch area may be a sum of contact areas of all the contact points of the click operation.

In some examples, the touch duration may refer to a duration the user stays on the touch surface of the display touch device while performing the touch operation. For example, the touch operation is a click operation with only one contact point, and the touch duration may refer to a duration that a single contact point of the click operation stays on the touch surface. For another example, the touch operation is a click operation and includes a plurality of contact points, and the touch duration may refer to a maximum duration that all the contact points of the click operation stay on the touch surface. For another example, the touch operation is a sliding operation, and the touch duration may refer to a contact duration that a contact point on the touch surface during the sliding operation.

In some examples, the touch sequence may refer to a moving direction of the user on the touch surface of the display touch device while performing the touch operation. For example, the touch operation is a sliding operation, and the touch sequence may refer to a moving direction of a contact point of the sliding operation on the touch surface.

In some examples, the haptic signal may be characterized through at least one of following parameters: a waveform type, a waveform amplitude, a waveform frequency. For example, by adjusting at least one of a waveform type, a waveform amplitude, and a waveform frequency, different haptic signals may be generated, thereby driving different haptic feedback effects.

In some examples, a feedback intensity of the haptic signal may be adjusted by setting at least one parameter of the haptic signal. For example, when the waveform type and waveform amplitude are the same, the higher the waveform frequency of the haptic signal is, the greater the feedback intensity is; the lower the waveform frequency of the haptic signal is, the smaller the feedback intensity is. For another example, when the waveform type and waveform frequency are the same, the greater the waveform amplitude of the haptic signal is, the greater the feedback intensity is, and the smaller the waveform amplitude of the haptic signal is, the smaller the feedback intensity is.

In some examples, the waveform frequency of the haptic signal may be less than or equal to 200 hertz (Hz). The haptic signal of the waveform frequency of this example helps to produce a film pressing effect with the finger, thereby changing a surface friction coefficient and giving a rich haptic feedback effect.

In some examples, the waveform type may include at least one of a pulse wave, a square wave, a triangular wave, a sinusoidal function wave, a sawtooth wave. Among them, in a case that the waveform amplitude and waveform frequency are equal, feedback intensities of the square wave and the rectangular wave are relatively small, while feedback intensities of the pulse wave, the triangular wave, and the sawtooth wave are relatively large. In some examples, a high-frequency pulse wave may be set as a haptic signal to realize a haptic feedback effect with a relatively large feedback intensity; by setting a low-frequency square wave as a haptic signal, a haptic feedback effect with a relatively small feedback intensity is achieved. The waveform type of the haptic signal is not limited in the present embodiment. In some examples, the above waveforms may be combined or transformed to generate a desired waveform.

In some examples, in act 11, determining the touch operation for the target object in the graphical user interface may include: determining that the touch operation is a touch operation for the target object when a touch position of the touch operation is located in a region where the target object is located, and a type of the target object matches a type of the touch operation. For example, after the touch operation is detected, it is possible to determine whether the touch operation is performed in the region where the target object is located according to the touch position of the touch operation and a position of the region where the target object is located; when the touch position of the touch operation is located in the region where the target object is located, and the type of the target object matches the type of the touch operation, it may be determined that the detected touch operation is a touch operation for the target object. When detecting that the detected touch position of the touch operation is not in the region where the target object is located, or the type of the target object does not match the type of the touch operation, it may be determined that the detected touch operation is not a touch operation for the target object.

In some examples, the type of target object may include at least one of a GUI control, a set multi-touch region. The GUI control may include a button control, a control bar control, and a knob control. The present embodiment is not limited thereto.

In some examples, the type of the touch operation may include at least a click operation and a sliding operation.

In some examples, a matching relationship between the type of the target object and the type of the touch operation may be set in advance, and after determining the type of the target object and the type of the touch operation, whether the type of the target object and the type of the touch operation match is determined according to a preset matching relationship. For example, the matching relationship between the type of the target object and the type of the touch operation may include at least one of: a button control matches a click operation, a control bar control matches a sliding operation, a knob control matches a sliding operation, and a multi-touch region matches a click operation. In some examples, a sliding operation for a button control is not considered a touch operation to start the button control and the interaction method of the present example cannot be triggered; a click operation for the control bar control is not considered to be a touch operation to start the control bar control and the interaction method of the present example cannot be triggered; a click operation for a knob control is not considered a touch action to start the knob control and the interaction method of present example cannot be triggered.

In some examples, act 12 may include: determining a corresponding relationship between the touch parameter information and a parameter of the haptic signal according to a type of the target object and a type of touch operation for the target object; and generating a haptic signal according to the touch parameter information and the corresponding relationship between the touch parameter information and the parameter of the haptic signal. For example, for a target object and a touch operation whose types have a matching relationship, a corresponding relationship between touch parameter information of the touch operation and a parameter of a haptic signal may be set in advance. After determining the type of the target object and the type of the touch operation match, a corresponding relationship between the touch parameter information of the touch operation and the parameter of the haptic signal may be determined, so as to generate a corresponding haptic signal according to the touch parameter information, thereby driving generation of a corresponding haptic feedback effect.

In some examples, when the target object includes a control bar control, and the touch operation for the target object is a sliding operation, it may be determined that a waveform frequency of the haptic signal depends on a touch position of the touch operation. In this example, for the sliding operation of the control bar control, the waveform frequency of the haptic signal may be changed according to change of a position of a contact point in a sliding process of the sliding operation, so that different haptic feedback results may be provided in a sliding operation process of the sliding operation, so as to enrich haptic feeling of the user.

In some examples, when the target object includes a button control, and the touch operation for the target object is a click operation, it may be determined that a waveform amplitude of the haptic signal depends on a touch pressure of the touch operation. In this example, for the click operation of the button control, the waveform amplitude of the haptic signal may be changed according to change of the touch pressure applied in a click process of the click operation, thereby giving different haptic feedback results to enrich haptic feeling of the user.

In some examples, when the target object includes a multi-touch region, and the touch operation for the target object is a click operation, it may be determined that a waveform type of the haptic signal depends on a quantity of touch points of the touch operation. In this example, for the click operation of the multi-touch region, the waveform type of the haptic signal may be changed according to change of the quantity of touch points in the click operation, thereby giving different haptic feedback results to enrich haptic feeling of the user.

Solutions of the embodiments will be described below through some examples.

FIG. 2 is a schematic diagram of a display touch device according to at least one embodiment of the present disclosure. In some examples, as shown in FIG. 2, the display touch device of the present embodiment may include a display touch panel 21, a haptic feedback apparatus 22, and a processor 23. The processor 23 is connected with the display touch panel 21 and the haptic feedback apparatus 22.

In some examples, the processor 23 may be a Microcontroller (MCU), a Central Processing Unit (CPU), a general purpose processor, a Digital Signal Processor (DSP), an Application Specific Integrated Circuit (ASIC), a Field-Programmable Gate Array (FPGA), or another programmable logic device, a transistor logic device, or any combination of the above structures. For example, the processor may be a combination that implements a computing function, such as may include one or more combinations of microprocessors, combinations of DSPs and microprocessors, and the like.

In some examples, the display touch panel 21 may include a display panel and a touch panel. The touch panel may collect a user's touch operation (e.g., a user's finger operate on the touch panel) thereon, and achieve a corresponding operation according to a preset program. For example, the user clicks on a quick identification of a function module. The touch panel may be achieved by various types such as resistive, capacitive, infrared, and surface acoustic wave. A capacitive touch panel works based on a principle that a size of a capacitance varies with a size of a finger pressure. A resistive touch panel works based on a principle that a size of a resistance of a varistor changes with a size of a finger pressure. For example, the touch panel may be a capacitive touch panel. In some examples, the touch panel may be configured to collect touch parameter information of the touch operation, such as collecting a touch position, a touch duration, a touch area, a quantity of touch points, and a touch sequence of the touch operation. In other examples, the display touch panel may be integrated with a pressure sensor (e.g., an optical fiber or a piezoelectric ceramic sheet) to collect a touch pressure of the touch operation.

In some examples, the touch panel may cover the display panel, after the touch panel detects a touch operation on it, the touch operation is sent to the processor to determine a type of a touch event, and then the processor provides corresponding interface output on the display panel according to the type of the touch event. The touch panel and the display panel may be used as two independent components to achieve input and output functions of a mobile terminal. In some examples, input and output functions may be implemented by integrating a touch panel and a display panel. For example, the display touch panel 21 may include a base substrate (such as a glass base substrate), and a display structure and a touch structure sequentially disposed on the base substrate.

In some examples, the haptic feedback apparatus 22 may include a piezoelectric structure (e.g., including a piezoelectric ceramic sheet or a piezoelectric thin film) and a drive circuit. The piezoelectric structure is electrically connected with the drive circuit. The drive circuit may receive a haptic signal from the processor 23, and drive the piezoelectric structure to generate a haptic feedback effect according to the haptic signal. For example, the haptic feedback apparatus 22 may be located on a side of the base substrate of the display touch panel 21 away from the touch structure; or, the haptic feedback apparatus 22 may be located on a side of the touch structure close to the base substrate. In some examples, the piezoelectric structure of the haptic feedback apparatus may simultaneously serve as a pressure sensor, achieving collection of a touch pressure of the touch operation. The present embodiment is not limited thereto. In other examples, the display touch device may be provided with a separate pressure transmitter for collection of a touch pressure.

In some examples, the haptic feedback effect generated by the haptic feedback apparatus may include a haptic feedback effect generated based on a film pressing effect. Among them, an air pressure film may be formed between a surface of the user's finger and a touch surface (such as a horizontal plane) of the display touch device, and the air pressure film has high pressure characteristics and a certain squeezing force, and the squeezing force may change a positive pressure of touching of the finger, thereby changing a relative friction coefficient between the finger and the touch surface, thereby producing a film pressing effect. Different touch feelings may be presented based on film pressing effects generated based on different haptic signals. In this example, a haptic feedback effect is given by using a film pressing effect, a more realistic touch feeling may be fed back to the user, user experience may be optimized, and user experience may be prevented from being influenced by an excessively strong or stimulating haptic feedback effect.

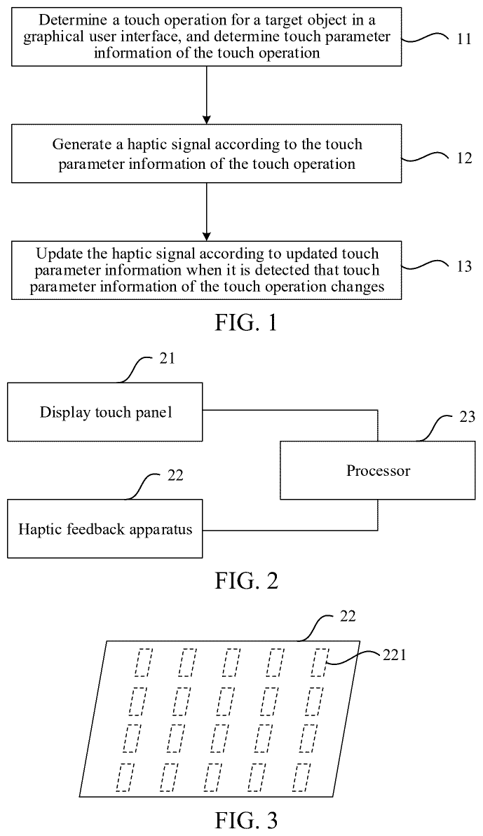

FIG. 3 is a schematic plan view of a haptic feedback apparatus according to at least one embodiment of the present disclosure. In some examples, as shown in FIG. 3, the piezoelectric structure of the haptic feedback apparatus 22 may include a plurality of piezoelectric ceramic sheets 221 arranged in an array. Under drive of the drive circuit, a piezoelectric ceramic sheet 221 at a corresponding position may vibrate, so that a touch surface is deformed in-plane and out-of-plane, thereby enabling the user's finger to feel a haptic feedback effect.

In some examples, a setting region of the piezoelectric ceramic sheet array may correspond to a touch region of the display touch device. The piezoelectric ceramic sheet array of the present example may simultaneously serve as a pressure sensor of the display touch device. For example, a plurality of piezoelectric ceramic sheets within a range of a contact point of a touch operation may collect a touch pressure of the touch operation, and data processing may be performed on the touch pressure collected by the plurality of piezoelectric ceramic sheets to determine the touch pressure of the contact point. For another example, one or more piezoelectric ceramic sheets within a range of a contact point of a touch operation may vibrate under drive of the drive circuit to achieve haptic feedback for the touch operation. However, the present embodiment is not limited thereto. In other examples, the plurality of piezoelectric ceramic sheets included in the haptic feedback apparatus may be disposed in a peripheral region of the display touch device, and the piezoelectric ceramic sheets may vibrate under drive of the drive circuit to achieve haptic feedback for the touch operation.

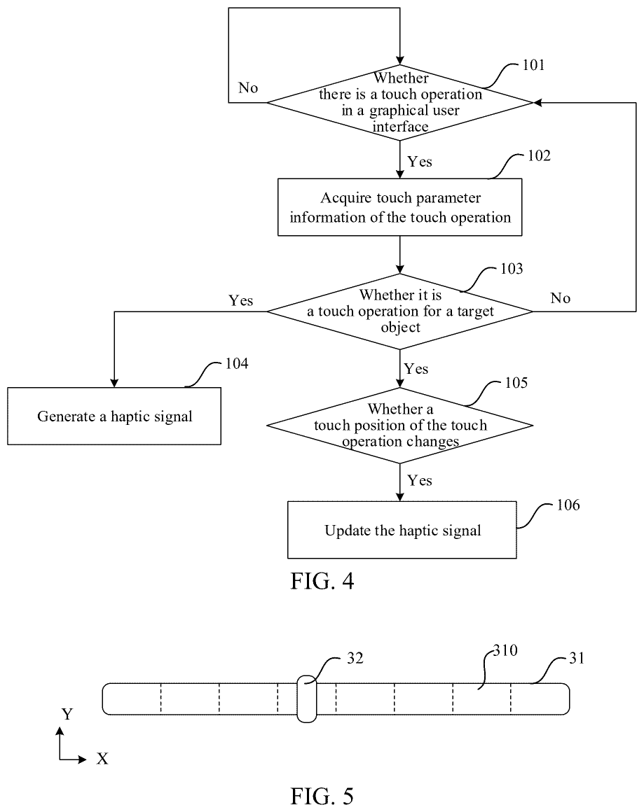

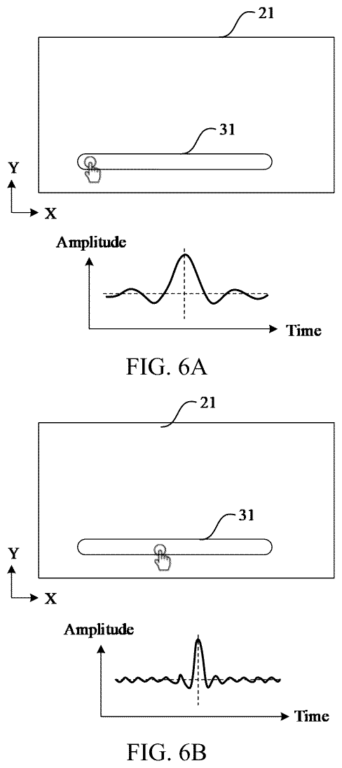

FIG. 4 is an exemplary flowchart of an interaction method according to at least one embodiment of the present disclosure. FIG. 5 is a schematic diagram of a control bar control according to at least one embodiment of the present disclosure. FIGS. 6A and 6B are operation example diagrams of at least one embodiment of the present disclosure. In this example, illustration is made by taking a case that a target object is a control bar control, and a touch operation matched with the control bar control is a sliding operation as an example.

In some examples, as shown in FIG. 4, the interaction method of the present example may include following acts.

Act 101: detecting whether there is a touch operation in a graphical user interface. In some examples, a display touch panel may detect whether there is a touch operation in the graphical user interface in real time or periodically.

In some examples, act 102 may be performed when the display touch panel detects a touch operation; when no touch operation is detected, it is possible to return to act 101 to continue detecting whether there is a touch operation, for example, it is possible to detect whether a touch operation occurs in real time.

Act 102: acquiring touch parameter information of the touch operation. In some examples, the display touch panel may acquire touch parameter information of the touch operation after detecting the touch operation. For example, the display touch panel may detect at least one of a touch position, a touch area, a quantity of touch points, a touch duration, and a touch sequence of the touch operation through a capacitive touch panel having a function of identifying a position of a contact point. For another example, the display touch panel may be integrated with a pressure sensor, and the pressure sensor is used to detect a touch pressure of the touch operation. In the present example, illustration is made by taking a case that the touch parameter information of the touch operation includes a touch position as an example.

Act 103: determining whether the touch operation is a touch operation for the target object. In some examples, when determining that the touch operation is a touch operation for the target object, acts 104 and 105 may be performed; when determining that the touch operation is not a touch operation for the target object, the touch operation may not be fed back, for example, the touch operation may be considered to be an erroneous operation, and a process returns to act 101.

In some examples, the display touch panel may transmit real-time or periodically collected touch parameter information of the touch operation to the processor. The processor may determine a type of the touch operation and whether the touch operation is located in a region where the target object is located according to the collected touch parameter information of the touch operation (including, for example, the touch position), and determine, in combination with a preset matching relationship between a type of the target object and the type of the touch operation, whether a type of the detected touch operation matches the type of the target object. For example, if it is identified that the detected touch operation is located in the region where the target object is located, and the type of the detected touch operation matches the type of the target object, the detected touch operation may be determined to be a touch operation for the target object. When it is identified that the touch operation is not located in the region where the target object is located, or the type of the detected touch operation does not match the type of the target object, it may be determined that the detected touch operation is not a touch operation of the target object. In this example, when it is identified that the detected touch operation is located in a region where a control bar control is located, and the detected touch operation is a sliding operation, it may be determined that the detected touch operation is a touch operation for the control bar control.

Act 104: generating a haptic signal according to the touch parameter information of the touch operation. In some examples, the processor may determine a corresponding relationship between the touch parameter information and a parameter of the haptic signal according to the type of the target object and the type of the touch operation, and generate a corresponding haptic signal according to the touch parameter information and the corresponding relationship between the touch parameter information and the parameter of the haptic signal. The processor may send the generated haptic signal to the haptic feedback apparatus, and the haptic feedback apparatus may generate a corresponding haptic feedback effect according to the haptic signal. In this example, a case that a waveform frequency of the haptic signal is adjusted through change of a touch position of the touch operation is taken as an example.

In some examples, as shown in FIG. 5, it is illustrated by taking a case that a control bar control 31 with a strip structure extending along a first direction X as an example. A second direction Y intersects with the first direction X, for example, the first direction X is perpendicular to the second direction Y. A plane on which the first direction X and the second direction Y are located may be, for example, parallel to a plane on which a touch surface of the display touch panel is located. The control bar control 31 may be configured for adjusting a function, e.g., adjusting a volume, adjusting brightness, and adjusting a temperature. The control bar control 31 may have a bar-shaped adjustment region on which a slider 32 is disposed. The slider 32 may be moved in the bar-shaped adjustment region to indicate a corresponding adjustment value. The user may realize a setting operation in the bar-shaped adjustment region by dragging the slider 32. For example, the user drags the slider 32 to move in the bar-shaped adjustment region along the first direction X, and may adjust the volume to gradually increase, or adjust the brightness to gradually increase; the user drags the slider 32 to move in the bar-shaped adjustment region along an opposite direction of the first direction X, and the volume or brightness may be adjusted to gradually decrease. In some examples, the slider 32 may be a rounded rectangular block. A shape of the slider is not limited in the present embodiment. For example, the slider 32 may be a circular block, or an elliptical block, or of an arrow-like structure located in the bar-shaped adjustment region. In other examples, the slider 32 may be hidden to be not displayed, and may be displayed upon detection of a touch operation located at the control bar control.

In some examples, as shown in FIG. 5, the control bar control 31 may be divided into a continuous plurality of first sub-regions 310 along a length direction of the control bar control 31. Areas of the plurality of first sub-regions 310 may be substantially the same. The present embodiment is not limited thereto. For example, the areas of the plurality of first sub-regions may be partially the same. For another example, the areas of the plurality of first sub-regions may be different, for example, may increase or decrease along the first direction.

In some examples, as shown in FIG. 5, waveform frequencies of haptic signals corresponding to the plurality of first sub-regions 310 of the control bar control 31 may vary along a length direction of the control bar control 31. For example, waveform frequencies of haptic signals corresponding to the plurality of first sub-regions 310 arranged along the first direction X may sequentially increase or sequentially decrease. When waveform types and waveform amplitudes of the haptic signals are the same, a feedback intensity of a haptic feedback effect may be changed by changing a waveform frequency, for example, the larger the feedback intensity is, the larger the waveform frequency is, and the smaller the feedback intensity is, the smaller the waveform frequency is. The waveform frequencies corresponding to the plurality of first sub-regions 310 of the control bar control 31 of the present example are different, which may enable feedback intensities of haptic feedback effects of the touch operation for different first sub-regions to be different, thereby it is convenient for the user to feel the haptic feedback effects with different feedback intensities in different first sub-regions of the control bar control.

In some examples, as shown in FIG. 5, taking a case that an adjustment value of the control bar control 31 along the first direction X gradually increases as an example, waveform frequencies corresponding to the plurality of first sub-regions 310 of the control bar control 31 along the first direction X may be sequentially increased. In this way, during a sliding operation of dragging the slider 32 along the first direction X, the user may feel haptic feedback effects with different feedback intensities, for example, feel increase of a feedback intensity along the first direction X. For example, the slider sliding on the control bar control along the first direction X may increase a volume, the slider sliding on the control bar control along an opposite direction of the first direction X may decrease the volume. By setting waveform frequencies corresponding to a continuous plurality of first sub-regions 310 along the first direction X to increase sequentially, feedback intensities corresponding to the continuous plurality of first sub-regions 310 along the first direction X may be gradually increased, during a sliding operation of dragging the slider along the first direction X, the user may feel a gradually increasing feedback effect, and during a sliding operation of dragging the slider in the opposite direction of the first direction X, the user may feel a gradually decreasing feedback effect.

In some examples, the processor may generate a haptic signal f1(x1, y1) according to a touch position of a sliding operation for the control bar control, for example, including a starting point position coordinate P1(x1, y1). Herein, x1 is an abscissa of a starting point position, y1 is an ordinate of the starting point position, and f1 is a waveform function. The waveform function corresponds to a waveform type, and waveform functions of different waveform types are different. The waveform function of this example may be a sinusoidal function, resulting in a sinusoidal function wave. Preset values may be adopted for a waveform type and a waveform amplitude of the haptic signal.

In some examples, after the processor determines a sliding operation for the control bar control, the haptic signal generated according to a touch position of the sliding operation may be as shown in FIG. 6A. As shown in FIG. 6A, a coordinate of a starting point position of the sliding operation is located within a first sub-region close to a left end of the control bar control, and a waveform frequency of a correspondingly generated haptic signal is relatively small.

In some examples, the processor may transmit the generated haptic signal to the haptic feedback apparatus so as to drive the haptic feedback apparatus to generate a corresponding haptic feedback effect. For example, the haptic feedback apparatus may drive a piezoelectric ceramic sheet corresponding to the touch position according to the haptic signal f1(x1, y1) to generate a vibration displacement conforming to a feedback intensity of the haptic signal, so that the user feels vibration or friction of the touch surface.

Act 105: determining whether the touch position of the touch operation changes. In some examples, the processor may determine whether the touch parameter information of the touch operation for the target object changes according to the touch parameter information of the touch operation collected in real time or periodically by the display touch panel. When it is detected that the touch parameter information of the touch operation for the target object changes, act 106 may be performed; when it is detected that the touch parameter information of the touch operation for the target object has not changed, the haptic signal generated in the act 104 is kept being output, and the touch operation is continuously detected to detect whether the touch operation for the target object is finished or not.

In some examples, for a sliding operation of the control bar control, a coordinate position of a contact point in a sliding operation process may be collected, e.g., a coordinate P2(x2, y2) of an intermediate point position of the sliding operation. According to the coordinate of the intermediate point position of the sliding operation, an updated haptic signal may be obtained as f2(x2, y2), wherein x2 is an abscissa of the intermediate point position, y2 is an ordinate of the intermediate point position, and f2 is a waveform function, for example, may be a sinusoidal function.

In some examples, the haptic signal generated by the processor according to the updated touch position of the sliding operation may be as shown in FIG. 6B. As shown in FIG. 6B, a coordinate of an intermediate point position of the sliding operation may be located within a first sub-region of an intermediate portion of the control bar control, and a waveform frequency of a correspondingly generated haptic signal may be relatively large. Waveform functions f1 and f2 may be a same waveform function, and a waveform frequency corresponding to the waveform function f2 is larger than a waveform frequency of the waveform function f1.

In some examples, the processor may transmit the updated haptic signal to the haptic feedback apparatus so as to drive the haptic feedback apparatus to update a corresponding haptic feedback effect. For example, the haptic feedback apparatus may drive a piezoelectric ceramic sheet corresponding to the updated touch position according to the haptic signal f2(x2, y2) to generate a vibration displacement conforming to a feedback intensity of the haptic signal, so that the user feels vibration of the touch surface. Compared with haptic feedback felt at a starting point position of the sliding operation, the user may feel haptic feedback with gradually increasing feedback intensity along a direction of the sliding operation.

In some examples, the haptic feedback apparatus may include a plurality of haptic feedback units (e.g., piezoelectric ceramic sheets), and the plurality of haptic feedback units may be arranged in an array. After receiving the haptic signal, the haptic feedback apparatus may drive a haptic feedback unit corresponding to the touch position of the touch operation to generate a haptic feedback effect. For example, a haptic feedback unit corresponding to the touch position or a haptic feedback unit adjacent to the touch position is driven to generate a vibration effect, so that the user's finger may feel haptic feedback.

In some examples, the processor may determine whether the touch position of the touch operation for the target object changes in real time or periodically, thereby achieving real-time updating or periodic updating of the haptic signal. In the present example, when it is detected that a touch position for the sliding operation of the control bar control changes, a haptic signal matched with a feedback intensity corresponding to a first sub-region where the touch position is located may be updated and output, so that a haptic feedback effect may change with change of the touch position of the sliding operation, thereby making a haptic feedback effect richer and beneficial to enhancing user experience.

In other examples, the target object is a control bar control, and the haptic signal may be determined according to the touch position and a touch sequence of the sliding operation. For example, the control bar control may correspond to a first order (e.g., an order of adjusting numerical values from large to small) and a second order (e.g., an order of adjusting numerical values from small to large), and waveform amplitudes of haptic signals corresponding to the first order and the second order may be different. For example, waveform amplitudes of haptic signals corresponding to the first order may be smaller than waveform amplitudes of haptic signals corresponding to the second order. After a sliding operation for the control bar control is detected, a waveform frequency of a haptic signal may be determined according to a touch position of the sliding operation, and a waveform amplitude of the haptic signal may be determined according to a touch sequence of the sliding operation to generate a corresponding haptic signal. After detecting that at least one of the touch position and the touch sequence of the sliding operation for the control bar control has changed, the waveform frequency may be updated according to an updated touch position, or, the waveform amplitude may be updated according to an updated touch sequence, or, the waveform frequency may be updated according to the updated touch position and the waveform amplitude may be updated according to the updated touch sequence. In this way, during the sliding operation for the control bar control, the user may feel different haptic feedback effects with change of the sliding operation, which may not only enhance user experience, but also help to guide an operation of the user.

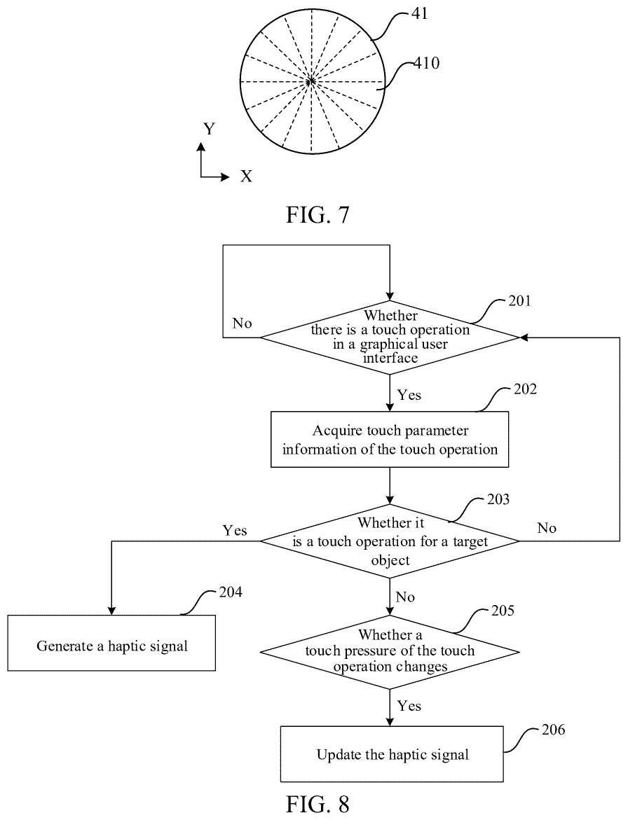

FIG. 7 is a schematic diagram of a knob control according to at least one embodiment of the present disclosure. In some examples, as shown in FIG. 7, the knob control 41 may be circular in shape. The present embodiment is not limited thereto. For example, a shape of the knob control may be a rounded rectangular shape, an oval shape, or the like.

In some examples, as shown in FIG. 7, the knob control 41 may be configured for adjusting a function, such as adjusting a temperature and adjusting a volume. A touch operation matched with the knob control 41 may be a sliding operation. The knob control 41 may be divided into a continuous plurality of second sub-regions 410 along a circumferential direction. The user may achieve function adjustment (for example, adjusting a volume change or adjusting a temperature change) through a sliding operation in the plurality of second sub-regions 410 of the knob control 41, and a corresponding haptic signal is generated according to a second sub-region 410 where a touch position of the sliding operation is located. Waveform frequencies of haptic signals corresponding to the plurality of second sub-regions 410 may be different. For example, waveform frequencies of haptic signals corresponding to the plurality of second sub-regions 410 arranged in a clockwise direction may sequentially increase or sequentially decrease. In this example, the user may feel haptic feedback effects with different feedback intensities during the sliding operation of the knob control. For example, sliding the knob control along the clockwise direction may increase a volume, sliding the knob control along a counterclockwise direction may decrease the volume. By setting waveform frequencies corresponding to the continuous plurality of second sub-regions along the clockwise direction to increase sequentially, feedback intensities corresponding to the continuous plurality of second sub-regions along the clockwise direction maybe gradually increased or decreased, and during the sliding operation, the user may feel that a feedback effect gradually enhanced along the clockwise direction, and a feedback effect gradually weakened along the counterclockwise direction.

As for the interaction method for the knob control, the description of the foregoing embodiments may be referred to, and thus description thereof will not be repeated here.

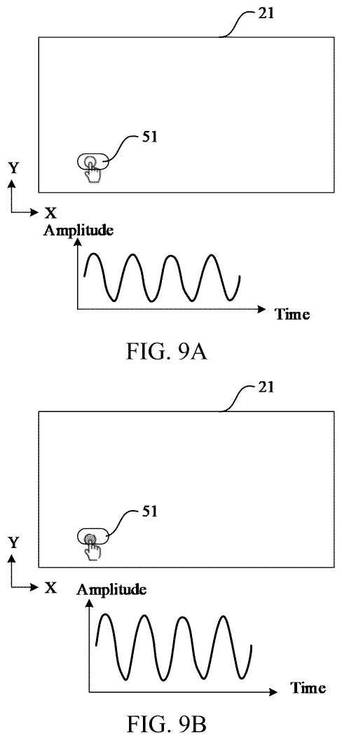

FIG. 8 is another exemplary flowchart of an interaction method according to at least one embodiment of the present disclosure. FIGS. 9A and 9B are operation example diagrams of at least one embodiment of the present disclosure. In this example, illustration is made by taking a case that the target object is a button control, and a touch operation matched with the button control is a click operation as an example.

In some examples, as shown in FIG. 8, the interaction method of the present example may include following acts.

Act 201: detecting whether there is a touch operation in a graphical user interface. In some examples, the display touch panel may detect whether there is a touch operation in the graphical user interface in real time or periodically.

Act 202: acquiring touch parameter information of the touch operation. In some examples, the display touch panel may acquire touch parameter information of the touch operation after the touch operation is detected. In the present example, the touch parameter information of the touch operation may include a touch position and a touch pressure. For example, the display touch panel may acquire a touch position through a capacitive touch panel and acquire a touch pressure through a piezoelectric ceramic sheet.

Act 203: determining whether the touch operation is a touch operation for a target object. In some examples, when determining that the touch operation is a touch operation for the target object, acts 204 and 205 may be performed; when determining that the touch operation is not a touch operation for the target object, the touch operation may not be fed back, for example, the touch operation may be considered to be an erroneous operation, and a process returns to act 201.

Act 204: generating a haptic signal according to the touch parameter information of the touch operation. In this example, it is taking a case that a waveform amplitude of the haptic signal is adjusted with change of the touch pressure of the touch operation as an example.

In some examples, as shown in FIGS. 9A and 9B, the button control 51 may be configured for implementing a start, close, or selection function. A shape of the button control 51 may be an elliptical shape. However, the present embodiment is not limited thereto. For example, the shape of the button control 51 may be a circular shape, a rectangular shape, or a rounded rectangular shape.

In some examples, the button control may be preset to correspond to a plurality of touch pressure ranges. For example, the plurality of touch pressure ranges may include a light clicking pressure range, a light pressing pressure range, and a heavy pressing pressure range. A pressure value of the light clicking pressure range is smaller than a pressure value of the light pressing pressure range, and the pressure value of the light pressing pressure range is smaller than a pressure value of the heavy pressing pressure range. Waveform amplitudes of haptic signals corresponding to the plurality of touch pressure ranges change with sizes of numerical values of the plurality of touch pressure ranges. For example, waveform amplitudes corresponding to the light clicking pressure range, the light pressing pressure range, and the heavy pressing pressure range may be increased sequentially. Division of the touch pressure ranges corresponding to the button control is not limited in the present embodiment. In other examples, different button controls may be set to correspond to different touch pressure ranges, for example, one button control may correspond to three touch pressure ranges and another button control may correspond to four or two touch pressure ranges.

In some examples, the processor may generate a haptic signal according to a touch pressure of a click operation for the button control. As shown in FIG. 9A, a touch pressure of the click operation for the button control belongs to the light clicking pressure range, and a haptic signal may be generated according to a waveform amplitude corresponding to the light clicking pressure range. Herein, preset values may be adopted for a waveform type and a waveform frequency of the haptic signal. For example, the haptic feedback apparatus may generate a waveform signal with a relatively weak amplitude to achieve a weak haptic feedback effect. In some examples, when the user gently presses the button control in the graphical user interface, the user may feel relatively weak vibration.

Act 205: determining whether a touch pressure of the touch operation changes. In some examples, act 206 may be performed when the processor detects that the touch pressure of the click operation for the button control; when it is detected that the touch pressure of the click operation for the button control has not changed, the haptic signal generated in the act 204 is kept being output, and the click operation is continued to be detected to detect whether the click operation for the button control is finished or not.

In some examples, the processor may update the haptic signal according to change of the touch pressure of the click operation for the button control. As shown in FIG. 9B, when the touch pressure of the click operation for the button control is updated to the heavy pressing pressure range, the haptic signal may be updated according to a waveform amplitude corresponding to the heavy pressing pressure range. For example, the haptic feedback apparatus may generate a waveform signal with a relatively strong amplitude to achieve a relatively strong haptic feedback effect. In some examples, when the user presses the button control heavily, the user may feel relatively strong vibration.

For detailed description of remaining acts of the interaction method of the present example, the description of the foregoing embodiments may be referred to, and therefore, description thereof will not be repeated here.

In this example, the piezoelectric ceramic sheets may be arranged in an array on the display touch panel, and may be used as pressure sensors during a collection process to convert a touch pressure signal into a voltage signal to achieve collection of a touch pressure; in a haptic feedback process, vibration corresponding to a haptic signal may also be generated under drive of the drive circuit to achieve haptic feedback.

In some examples, as shown in FIGS. 9A and 9B, in a process that the touch pressure changes from small to large during the user's click operation on the button control, the haptic feedback apparatus may give vibration from small to large, so that the user may feel change of a haptic feedback effect when pressing a same position due to different touch pressures, which is more conforming with user experience in a process of human-computer interaction. Furthermore, a feedback intensity of vibration feedback given by the haptic feedback apparatus is related to the touch pressure of the click operation, and an operation prompt may be given to the user, such as prompting that the user exerting too much force or exerting too little force.

In some examples, the button control may be a control button of a video playback class application. Light clicking the button control may start video playback or pause video playback; light pressing the button control may perform a video fast-forward operation; heavily pressing the button control may perform a video fast-backward operation. In a process of clicking on the button control, the user may control to achieve different functions by controlling an exerted touch pressure, and different haptic feedback effects may be driven according to different touch pressures, and the user may feel a rich haptic feedback effect in a process of the click operation, and may adjust the touch pressure as needed according to the haptic feedback effect to achieve a required function.

In other examples, the target object is a button control, and the haptic signal may be determined according to a touch pressure and a touch duration of a click operation. For example, a click operation of the button control may correspond to a plurality of touch duration ranges, and the plurality of touch duration ranges may be different. For example, the plurality of touch duration ranges may include a first duration range, a second duration range, and a third duration range, the first duration range is less than a first duration, the second duration range is greater than or equal to the first duration and less than a second duration, and the third duration range being greater than or equal to the second duration. Herein, the first duration may be less than the second duration, and both the first duration and the second duration may be greater than zero. Waveform frequencies of haptic signals corresponding to the first duration range, the second duration range, and the third duration range may be different. For example, a waveform frequency corresponding to the first duration range may be smaller than a waveform frequency corresponding to the second duration range, and the waveform frequency corresponding to the second duration range may be smaller than a waveform frequency corresponding to the third duration range. After detecting the click operation for the button control, a waveform amplitude of a haptic signal may be determined according to a touch pressure of the click operation, and a waveform frequency of the haptic signal may be determined according to a touch duration of the click operation to generate the corresponding haptic signal. After detecting that at least one of the touch pressure and the touch duration of the click operation for the button control changes, the waveform amplitude may be updated according to an updated touch pressure, or, the waveform frequency may be updated according to an updated touch duration, or, the waveform amplitude may be updated according to the updated touch pressure and the waveform frequency may be updated according to the updated touch duration. In this way, in a process of the click operation on the button control, the user may feel different haptic feedback effects with change of the click operation, which may not only enhance user experience, but also help to guide an operation of the user to achieve a function that the user wants to achieve.

In other examples, the target object is a button control, and a haptic signal may be determined according to a touch duration of a click operation. For example, the click operation of the button control may correspond to a plurality of touch duration ranges, wherein the plurality of touch duration ranges may be different. Waveform frequencies corresponding to the plurality of touch duration ranges may be different. After detecting the click operation for the button control, a waveform frequency of a haptic signal may be determined according to a touch duration of the click operation to generate the corresponding haptic signal. After detecting that the touch duration of the click operation for the button control changes, the waveform frequency may be updated according to an updated touch duration.

In other examples, the target object is a button control, and a haptic signal may be determined according to a touch area of a click operation. For example, the click operation of the button control may correspond to a plurality of touch area ranges, wherein the plurality of touch area ranges may be different, and waveform frequencies or waveform amplitudes corresponding to the plurality of touch area ranges may be different. After detecting the click operation for the button control, a waveform frequency or waveform amplitude of a haptic signal may be determined according to a touch area of the click operation to generate the corresponding haptic signal. After detecting that the touch area of the click operation for the button control changes, the waveform frequency or waveform amplitude may be updated according to an updated touch area.

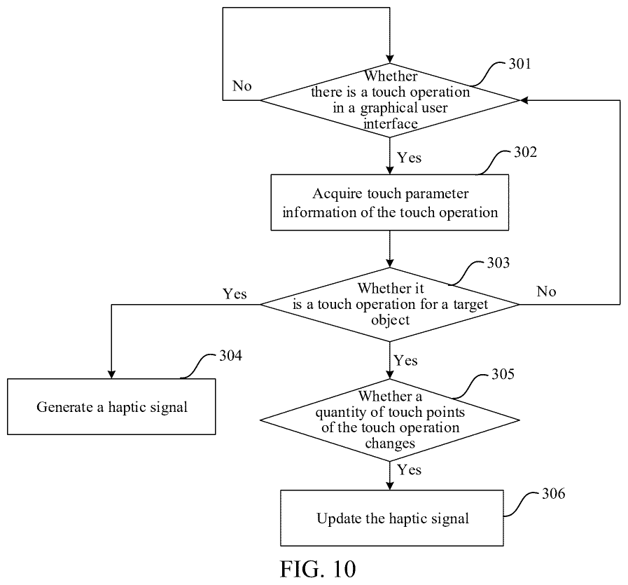

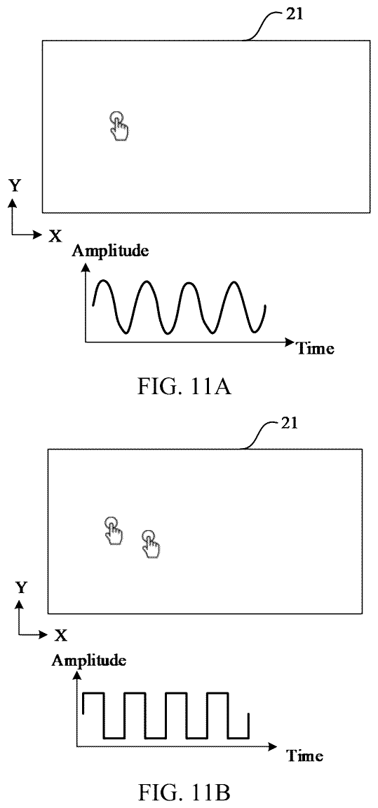

FIG. 10 is another flowchart of an interaction method according to at least one embodiment of the present disclosure. FIGS. 11A and 11B are operation example diagrams of at least one embodiment of the present disclosure. In this example, illustration is made by taking a case that the target object is a multi-touch region and a touch operation matched with the multi-touch region is a click operation as an example.

In some examples, as shown in FIG. 10, the interaction method of the present example may include following acts.

Act 301: detecting whether there is a touch operation in a graphical user interface. In some examples, the display touch panel may detect whether there is a touch operation in a graphical user interface in real time or periodically.

Act 302: acquiring touch parameter information of the touch operation. In some examples, the display touch panel may acquire touch parameter information of the touch operation after detecting the touch operation. In the present example, the touch parameter information of the touch operation may include a touch position and a quantity of touch points. For example, the display touch panel may acquire the touch position and the quantity of touch points through a capacitive touch panel.

Act 303: determining whether the touch operation is a touch operation for the target object. In some examples, when determining that the touch operation is a touch operation for the target object, acts 304 and 305 may be performed; when determining that the touch operation is not a touch operation for the target object, the touch operation may not be fed back, for example, the touch operation may be considered to be an erroneous operation, and a process returns to act 301.

Act 304: generating a haptic signal according to the touch parameter information of the touch operation. In this example, a case that a waveform type of the haptic signal is adjusted with change of the quantity of touch points of the click operation is taken as an example.

In some examples, as shown in FIGS. 11A and 11B, a set multi-touch region of the graphical user interface may serve as a target object, for example, the target object may be a blank region displayed in the graphical user interface.

In some examples, a multi-touch region may be preset to correspond to a plurality of contact point ranges. For example, the plurality of contact point ranges may include a first contact point range, a second contact point range, and a third contact point range. The first contact point range may be less than or equal to a first number, the second contact point range may be greater than the first number and less than or equal to a second number, and the third contact point range may be greater than the second number, wherein the second number may be greater than the first number. Division of the contact point ranges corresponding to the multi-touch region is not limited in the present embodiment. In other examples, different multi-touch regions may be set to correspond to different contact point ranges, for example, one multi-touch region may correspond to three contact point ranges, and another multi-touch region may correspond to two or four contact point ranges.

In some examples, the processor may generate a haptic signal according to a quantity of touch points of a click operation for the multi-touch region. As shown in FIG. 11A, the quantity of touch points of the click operation for the multi-touch region is one, for example, belonging to the first contact point range, and the haptic signal may be generated according to a waveform type corresponding to the first contact point range. For example, the first contact point range corresponds to a sinusoidal function wave, and preset values may be adopted for a waveform frequency and a waveform amplitude of the haptic signal.

In some examples, as shown in FIG. 11A, the click operation for the multi-touch region is a single-touch operation with one contact point whose coordinate position is Q1(x3, y3). The processor may generate a haptic signal g1(x3, y3), wherein x3 is an abscissa of the contact point, y3 is an ordinate of the contact point, and g1 is a waveform function. In this example, a waveform type corresponding to the first contact point range is a sinusoidal function wave, and the waveform function g1 is a sinusoidal function. For example, the drive circuit of the haptic feedback apparatus may drive a piezoelectric ceramic sheet corresponding to a position of the contact point, to generate vibration feedback corresponding to a feedback intensity of the haptic signal. In some examples, when the user single-touches the target object, it may be implemented to enter a page of a next level.

Act 305: determining whether the quantity of touch points of the touch operation changes. In some examples, act 306 may be performed when the processor detects that the quantity of touch points of the click operation for the multi-touch region changes; when it is detected that the quantity of touch points of the click operation for the multi-touch region has not changed, the haptic signal generated in act 304 is kept being output, and the click operation is continued to be detected to detect whether the click operation for the multi-touch region is finished or not.

In some examples, the processor may update the haptic signal according to change of the quantity of touch points of the click operation for the multi-touch region. As shown in FIG. 11B, when the quantity of touch points of the click operation for the multi-touch region is two, for example, belonging to the second contact point range, the haptic signal may be generated according to a waveform type corresponding to the second contact point range. For example, the second contact point range corresponds to a rectangular wave, and preset values may be adopted for a waveform frequency and a waveform amplitude of the haptic signal.

In some examples, as shown in FIG. 11B, the click operation for the multi-touch region is a multi-touch operation with two contact points, and coordinate positions of the two contact points are Q1(x3, y3) and Q2(x4, y4). The processor may generate haptic signals g2(x3, y3) and g2(x4, y4), wherein g2 is a rectangular wave function. For example, the drive circuit of the haptic feedback apparatus may drive a piezoelectric ceramic sheet corresponding to the positions of the two contact points to generate vibration feedback corresponding to a feedback intensity of the haptic signal. In some examples, when the user multi-touches the target object, it may be implemented to return to a page of a previous level.

For detailed description of remaining acts of the interaction method of the present example, the description of the foregoing embodiments may be referred to, and therefore, description thereof will not be repeated here.

In the present example, as shown in FIGS. 11A and 11B, in a process of switching the quantity of touch points of the user's click operation on the multi-touch region from a single point to two points, the processor may generate haptic signals with different waveform types, so that the haptic feedback apparatus may give haptic feedback effects with different intensities, and the user may feel change of a haptic feedback effect by changing the quantity of touch points when performing the click operation on a same region, which is more conforming with user experience in a process of human-computer interaction. Further, a feedback intensity of vibration feedback given by the haptic feedback apparatus is related to the quantity of touch points of the click operation, and an operation prompt may be given to the user.

In other examples, the target object may be a multi-touch region, and a haptic signal is determined according to a quantity of touch points and a touch area of a click operation. In the present example, a touch area acquired at a certain moment may refer to a sum of touch areas of all contact points of the click operation at that moment. For example, the click operation of the multi-touch region may correspond to a plurality of touch area ranges, wherein the plurality of touch area ranges may be different, and waveform frequencies or waveform amplitudes corresponding to the plurality of touch area ranges may be different. After detecting the click operation for the multi-touch region, a waveform type of a haptic signal may be determined according to a quantity of touch points of the click operation, and a waveform frequency may be determined according to a touch area to generate the corresponding haptic signal. After detecting that at least one of the quantity of touch points and the touch area of the click operation changes, the waveform type may be updated according to an updated quantity of touch points, or, the waveform frequency may be updated according to an updated touch area, or, the waveform type may be updated according to the updated quantity of touch points and the waveform frequency may be updated according to the updated touch area. In this way, in a process of the click operation on the multi-touch region, the user may feel different haptic feedback effects with change of the click operation, which may not only enhance user experience, but also help to guide the user's operation to achieve a desired function.

In other examples, the target object may include an application program icon, a displayed image, a file icon, and the like. For example, a click operation for a displayed image may achieve a zoom in or zoom out function of an image, and a corresponding haptic signal may be generated according to touch parameter information of the click operation to achieve a rich haptic feedback effect. For another example, a drag operation for a file icon may achieve functions such as file opening, file deleting, or file sending, and a corresponding haptic signal is generated according to touch parameter information of the drag operation to achieve haptic feedback. The present embodiment is not limited thereto.

In other examples, a corresponding relationship between touch parameter information of a touch operation for a target object and a parameter of a haptic signal may be adjusted or matched according to an actual application scenario to meet actual usage requirements. The present embodiment is not limited thereto.

In the interaction method provided by the present embodiment, touch parameter information of a touch operation may be detected on a graphical user interface, and different haptic feedback effects may be driven to be fed back based on change of the touch parameter information, thereby generating rich haptic feedback effects. This example may not only increase diverse experience of interaction, but also effectively guide the user's touch operation.

An embodiment also provides a display touch device, including: a display touch panel, a processor, and a haptic feedback apparatus, wherein the processor is connected with the display touch panel and the haptic feedback apparatus. The display touch panel is configured to acquire touch parameter information of a touch operation in a graphical user interface. The processor is configured to: determine a touch operation for a target object in a graphical user interface; generate a haptic signal according to the touch parameter information of the touch operation; and when it is detected that the touch parameter information of the touch operation changes, update the haptic signal according to updated touch parameter information. The touch parameter information includes at least one of a touch position, a touch pressure, a quantity of touch points, a touch area, a touch duration, and a touch sequence. The haptic feedback apparatus is configured to generate a corresponding haptic feedback effect according to the haptic signal.

In some exemplary implementation modes, the haptic signal is characterized by at least one of following parameters: a waveform type, a waveform amplitude, and a waveform frequency.

In some exemplary implementation modes, the processor is configured to generate a haptic signal according to the touch parameter information of the touch operation by means of: determining a corresponding relationship between the touch parameter information and a parameter of the haptic signal according to a type of the target object and a type of the touch operation for the target object; generating the haptic signal according to the touch parameter information and the corresponding relationship between the touch parameter information and the parameter of the haptic signal.

In some exemplary implementation modes, the processor is configured to determine a corresponding relationship between the touch parameter information and a parameter of a haptic signal according to a type of the target object and a type of touch operation for the target object by at least one of following: when the target object includes a control bar control and the touch operation for the target object is a sliding operation, determining that a waveform frequency of the haptic signal depends on a touch position of the touch operation; when the target object includes a button control and the touch operation for the target object is a click operation, determining that a waveform amplitude of the haptic signal depends on a touch pressure of the touch operation; when the target object includes a multi-touch region, and the touch operation for the target object is a click operation, determining that a waveform type of the haptic signal depends on a quantity of touch points of the touch operation.

In some exemplary implementation modes, the control bar control is divided into a plurality of first sub-regions along a length direction of the control bar control, and waveform frequencies of haptic signals corresponding to the plurality of first sub-regions change along the length direction of the control bar control. When the target object includes a control bar control, and the touch operation for the target object is a sliding operation, the processor is configured to generate the haptic signal according to the touch parameter information and a corresponding relationship between the touch parameter information and a parameter of the haptic signal by means of: determining a first sub-region where a contact point is located in the control bar control according to a touch position of the contact point of the sliding operation; and generating the haptic signal according to a waveform frequency corresponding to the first sub-region.

In some exemplary implementation modes, the button control corresponds to a plurality of touch pressure ranges, and waveform amplitudes of haptic signals corresponding to the plurality of touch pressure ranges change with numerical values of the plurality of touch pressure ranges. When the target object includes a button control, and the touch operation for the target object is a click operation, the processor is configured to generate the haptic signal according to the touch parameter information and a corresponding relationship between the touch parameter information and a parameter of the haptic signal by means of: determining a touch pressure range to which a touch pressure of the click operation belongs according to the touch pressure of the click operation; and generating the haptic signal according to a waveform amplitude corresponding to the determined touch pressure range.

In some exemplary implementation modes, the multi-touch region corresponds to a plurality of contact point ranges, and waveform types corresponding to the plurality of contact point ranges are different. When the target object includes a multi-touch region, and the touch operation for the target object is a click operation, the processor is configured to generate the haptic signal according to the touch parameter information and a corresponding relationship between the touch parameter information and a parameter of the haptic signal by means of: determining a contact point range to which a quantity of touch points belongs according to the quantity of touch points of the click operation; and generating the haptic signal according to a waveform type corresponding to the determined contact point range.

In some exemplary implementation modes, the haptic feedback apparatus includes at least a piezoelectric ceramic sheet.

Description of the display touch device of the present embodiment may refer to the description of the aforementioned embodiments, and thus will not be repeated here.

In addition, at least one embodiment of the present disclosure also provides a non-transitory computer readable storage medium on which a computer program is stored, wherein when the computer program is executed, acts of the above-mentioned interaction method are implemented.

Those of ordinary skills in the art may understand that all or some of acts in the methods disclosed above, systems, functional modules or units in apparatuses may be implemented as software, firmware, hardware, and an appropriate combination thereof. In a hardware implementation mode, division of the function modules/units mentioned in the above description is not always corresponding to division of physical components. For example, one physical component may have multiple functions, or one function or act may be executed by several physical components in cooperation. Some components or all components may be implemented as software executed by a processor such as a digital signal processor or a microprocessor, or implemented as hardware, or implemented as an integrated circuit such as an application specific integrated circuit. Such software may be distributed on a computer readable medium, and the computer readable medium may include a computer storage medium (or a non-transitory medium) and a communication medium (or a transitory medium). As known to those of ordinary skills in the art, a term computer storage medium includes volatile and nonvolatile, and removable and irremovable media implemented in any method or technology for storing information (for example, a computer readable instruction, a data structure, a program module, or other data). The computer storage medium includes, but is not limited to, a Random Access Memory (RAM), a Read-Only Memory (ROM), an Electrically Erasable Programmable ROM (EEPROM), a flash memory or other memory technologies, a Compact Disc Read-Only Memory (CD-ROM), a Digital Video Disk (DVD) or other optical storage, a cassette, a magnetic tape, magnetic disk storage or other magnetic storage apparatus, or any other medium that may be configured to store desired information and may be accessed by a computer. In addition, it is known to those of ordinary skill in the art that the communication medium usually includes a computer readable instruction, a data structure, a program module, or other data in a modulated data signal, such as, a carrier wave or another transmission mechanism, and may include any information delivery medium.

The above shows and describes basic principles, main features, and advantages of the present disclosure. The present disclosure is not limited by the above embodiments. The above embodiments and description in the specification only illustrate principles of the present disclosure. Without departing from the spirit and scope of the present disclosure, there will be many changes and improvements in the present disclosure, and all of these changes and improvements fall within the protection scope of the present disclosure.

1. An interaction method, comprising:
determining a touch operation for a target object in a graphical user interface, and determining touch parameter information of the touch operation; wherein the touch parameter information comprises at least one of following: a touch position, a touch pressure, a quantity of touch points, a touch area, a touch duration, and a touch sequence;
generating a haptic signal according to the touch parameter information of the touch operation, wherein the haptic signal is configured to drive a haptic feedback apparatus to generate a corresponding haptic feedback effect; and
when it is detected that the touch parameter information of the touch operation changes, updating the haptic signal according to updated touch parameter information.

2. The method according to claim 1, wherein the haptic signal is characterized by at least one of following parameters: a waveform type, a waveform amplitude, and a waveform frequency.

3. The method according to claim 2, wherein the generating the haptic signal according to the touch parameter information of the touch operation comprises:
determining a corresponding relationship between the touch parameter information and a parameter of the haptic signal according to a type of the target object and a type of the touch operation for the target object; and
generating the haptic signal according to the touch parameter information and the corresponding relationship between the touch parameter information and the parameter of the haptic signal.

4. The method according to claim 3, wherein the determining the corresponding relationship between the touch parameter information and the parameter of the haptic signal according to the type of the target object and the type of the touch operation for the target object comprises at least one of following:
when the target object comprises a control bar control and the touch operation for the target object is a sliding operation, determining that a waveform frequency of the haptic signal depends on a touch position of the touch operation;
when the target object comprises a button control and the touch operation for the target object is a click operation, determining that a waveform amplitude of the haptic signal depends on a touch pressure of the touch operation; and
when the target object comprises a multi-touch region and the touch operation for the target object is a click operation, determining that a waveform type of the haptic signal depends on a quantity of touch points of the touch operation.

5. The method according to claim 4, wherein the control bar control is divided into a plurality of first sub-regions along a length direction of the control bar control, and waveform frequencies of haptic signals corresponding to the plurality of first sub-regions change along the length direction of the control bar control;
when the target object comprises the control bar control and the touch operation for the target object is the sliding operation, the generating the haptic signal according to the touch parameter information and the corresponding relationship between the touch parameter information and the parameter of the haptic signal comprises: determining a first sub-region where a contact point is located in the control bar control according to a touch position of the contact point of the sliding operation; and generating the haptic signal according to a waveform frequency corresponding to the first sub-region.

6. The method according to claim 5, wherein the updating the haptic signal according to the updated touch parameter information comprises: determining a first sub-region where the contact point is located in the control bar control according to an updated touch position of the contact point of the sliding operation; and updating the haptic signal according to a waveform frequency corresponding to the first sub-region.

7. The method according to claim 4, wherein the button control corresponds to a plurality of touch pressure ranges, and waveform amplitudes of haptic signals corresponding to the plurality of touch pressure ranges change with numerical values of the plurality of touch pressure ranges;
when the target object comprises the button control and the touch operation for the target object is the click operation, the generating the haptic signal according to the touch parameter information and the corresponding relationship between the touch parameter information and the parameter of the haptic signal comprises: determining a touch pressure range to which a touch pressure of the click operation belongs according to the touch pressure of the click operation; and generating the haptic signal according to a waveform amplitude corresponding to the determined touch pressure range.

8. The method according to claim 7, wherein the updating the haptic signal according to the updated touch parameter information comprises: determining a touch pressure range to which an updated touch pressure belongs according to the updated touch pressure of the click operation; and updating the haptic signal according to a waveform amplitude corresponding to the updated touch pressure range.

9. The method according to claim 4, wherein the multi-touch region corresponds to a plurality of contact point ranges, and waveform types corresponding to the plurality of contact point ranges are different;
when the target object comprises the multi-touch region and the touch operation for the target object is the click operation, the generating the haptic signal according to the touch parameter information and the corresponding relationship between the touch parameter information and the parameter of the haptic signal comprises: determining a contact point range to which a quantity of touch points belongs according to the quantity of touch points of the click operation; and generating the haptic signal according to a waveform type corresponding to the determined contact point range.

10. The method according to claim 9, wherein the updating the haptic signal according to the updated touch parameter information comprises: determining a contact point range to which an updated quantity of touch points belongs according to the updated quantity of touch points of the click operation; and updating the haptic signal according to a waveform type corresponding to the updated contact point range.

11. The method according to claim 1, wherein the haptic feedback effect comprises a haptic feedback effect generated based on a film pressing effect.

12. The method according to claim 1, wherein the determining the touch operation for the target object in the graphical user interface comprises:
determining that the touch operation is a touch operation for the target object, when a touch position of the touch operation is located in a region where the target object is located and a type of the target object matches a type of the touch operation.

13. A display touch device, comprising:
a display touch panel, a processor, and a haptic feedback apparatus, wherein the processor is connected with the display touch panel and the haptic feedback apparatus;
the display touch panel is configured to acquire touch parameter information of a touch operation in a graphical user interface; the touch parameter information comprises at least one of following: a touch position, a touch pressure, a quantity of touch points, a touch area, a touch duration, and a touch sequence;
the processor is configured to: determine a touch operation for a target object in the graphical user interface; generate a haptic signal according to touch parameter information of the touch operation, and when it is detected that the touch parameter information of the touch operation changes, update the haptic signal according to updated touch parameter information; and
the haptic feedback apparatus is configured to generate a corresponding haptic feedback effect according to the haptic signal.

14. The display touch device according to claim 13, wherein the haptic signal is characterized by at least one of following parameters: a waveform type, a waveform amplitude, and a waveform frequency.

15. The display touch device according to claim 14, wherein the processor is configured to generate the haptic signal according to the touch parameter information of the touch operation by:
determining a corresponding relationship between the touch parameter information and a parameter of the haptic signal according to a type of the target object and a type of the touch operation for the target object; and
generating the haptic signal according to the touch parameter information and the corresponding relationship between the touch parameter information and the parameter of the haptic signal.

16. The display touch device according to claim 15, wherein the processor is configured to determine the corresponding relationship between the touch parameter information and the parameter of the haptic signal according to the type of the target object and the type of the touch operation for the target object by at least one of following:
when the target object comprises a control bar control and the touch operation for the target object is a sliding operation, determining that a waveform frequency of the haptic signal depends on a touch position of the touch operation;
when the target object comprises a button control and the touch operation for the target object is a click operation, determining that a waveform amplitude of the haptic signal depends on a touch pressure of the touch operation; and
when the target object comprises a multi-touch region and the touch operation for the target object is a click operation, determining that a waveform type of the haptic signal depends on a quantity of touch points of the touch operation.

17. The display touch device according to claim 16, wherein the control bar control is divided into a plurality of first sub-regions along a length direction of the control bar control, and waveform frequencies of haptic signals corresponding to the plurality of first sub-regions change along the length direction of the control bar control;
when the target object comprises a control bar control and the touch operation for the target object is a sliding operation, the processor is configured to generate the haptic signal according to the touch parameter information and the corresponding relationship between the touch parameter information and the parameter of the haptic signal by:
determining a first sub-region where a contact point is located in the control bar control according to a touch position of the contact point of the sliding operation; and generating the haptic signal according to a waveform frequency corresponding to the first sub-region.

18. The display touch device according to claim 16, wherein the button control corresponds to a plurality of touch pressure ranges, and waveform amplitudes of haptic signals corresponding to the plurality of touch pressure ranges change with numerical values of the plurality of touch pressure ranges;
when the target object comprises the button control and the touch operation for the target object is the click operation, the processor is configured to generate the haptic signal according to the touch parameter information and the corresponding relationship between the touch parameter information and the parameter of the haptic signal by:
determining a touch pressure range to which a touch pressure of the click operation belongs according to the touch pressure of the click operation; and generating the haptic signal according to a waveform amplitude corresponding to the determined touch pressure range.

19. The display touch device according to claim 16, wherein the multi-touch region corresponds to a plurality of contact point ranges, and waveform types corresponding to the plurality of contact point ranges are different;
when the target object comprises the multi-touch region and the touch operation for the target object is the click operation, the processor is configured to generate the haptic signal according to the touch parameter information and the corresponding relationship between the touch parameter information and the parameter of the haptic signal by:
determining a contact point range to which a quantity of touch points belongs according to the quantity of touch points of the click operation; and generating the haptic signal according to a waveform type corresponding to the determined contact point range.

20. (canceled)

21. A non-transitory computer readable storage medium, on which a computer program is stored, wherein when the computer program is executed, acts of an interaction method according to claim 1 are implemented.
